(19) United States
(12) Patent Application Publication
(10) Pub. No.: US 2012/0059947 A1
(43) Pub. Date: Mar. 8, 2012

(54) APPARATUS, SYSTEMS AND METHODS FOR STORING MUSIC PROGRAM CONTENT EVENTS RECEIVED IN A CONTENT STREAM

(75) Inventor: Dale Mountain, Silsden (GB)

(73) Assignee: ELDON TECHNOLOGY LIMITED, Steeton (GB)

(21) Appl. No.: 12/876,383

(22) Filed: Sep. 7, 2010

(51) Int. Cl. G06F 15/16; G06F 17/00

(52) U.S. Cl. 709/231; 700/94

(57) ABSTRACT

Systems and methods are operable to store music program content events received in a content stream. An exemplary system and method stores the content stream that includes at least an initial portion of a music program content event, receives a request to store the music program content event, accesses the stored content stream, identifies a start of the music program content event in the accessed content stream, and re-stores the initial portion of the music program content event based upon the start of the music program content event. Then, the exemplary system and method receives a continuing portion of the music program content event in the content stream, and stores the continuing portion of the music program content event with the initial portion of the music program content event. Accordingly, an entirety of the music program content event is stored.

### BACKGROUND

Media devices, such as a set top box (STB), a stereo, a television, a computer system, or the like, may be configured to receive streaming music program content. Such media devices may receive music program content from a variety of sources. An exemplary source of music program content is a web site that provides the music program content to the media device over a connection, such as the Internet. Another exemplary source is a portable memory medium, such as a compact disk (CD), a digital video disk (DVD), or the like. Yet another exemplary source is a content provider that is sourcing the media device over a high capacity system, such as a cable system, a fiber optic system, or a satellite system.

The user may store the received music program content in a variety of manners. Digital “jukebox” systems are available to assist the user in storing, managing and accessing their stored music program content. Some types of music program content may be relatively easy for the user to store. For example, a song downloaded from a web site over the Internet is typically configured as a discrete unit of music, and likely includes information of interest such as the song title, album title, artist identity, recording label identity, recording date, etc.

However, other types of music program content may be more difficult for the user to store. For example, when the media device is a STB, the music program content stream may be received as a continuous stream of music program content (audio and/or video) that is provided by a programming source, such as a music channel or the like. Here, a series of music program content events (e.g.; a series of music videos) are continuously streamed to the media device. The series music program content “events” are viewable on a media presentation device, such as a television (TV).

For individual music program content events in the continuous stream of music program content, some information may be available that identifies the individual music program content event as it is presented. The information may be presented as a pop up block that displays the information of interest pertaining to the currently presented music program content event. However, the music program content events are not subdivided, at the data level of the continuous stream of music program content, into discrete units. That is, the individual music program content events received by the STB are not configured for convenient saving as individual music program content events. Rather, the music program content stream may be saved by the STB, such as into its digital video recorder (DVR) or other storage media coupled to the STB.

Further, reviewing such stored music program content may be relatively difficult, particularly if the DVR or other storage media is not configured to separately indicate information, such as in a menu or the like, about individual stored music program content events. Further, when a selected continuous stream of music program content with multiple music program content events is saved into the DVR by the user, later display of the content available on the DVR will indicate only a limited amount of information, such as the identity of the continuous stream of music program content (i.e.; station and/or channel identifier of the recorded music channel), and/or the time and date of the recording. The DVR is not configured to present information pertaining to the individual music program content events (e.g.; song title, album title, artist identity, recording label identity, recording date, etc.).

Accordingly, there is a need in the arts to provide a more user-friendly way to record music program content events of interest that are received from the content provider that is sourcing the media device over the high capacity system.

### SUMMARY

Systems and methods of storing music program content events received in a content stream are disclosed. An exemplary embodiment stores the content stream that includes at least an initial portion of a music program content event, receives a request to store the music program content event, accesses the stored content stream, identifies a start of the music program content event in the accessed content stream, and re-stores the initial portion of the music program content event based upon the start of the music program content event. Then, the exemplary embodiment receives a continuing portion of the music program content event in the content stream, and stores the continuing portion of the music program content event with the initial portion of the music program content event. Accordingly, an entirety of the music program content event is stored.

### BRIEF DESCRIPTION OF THE DRAWINGS

Preferred and alternative embodiments are described in detail below with reference to the following drawings:

FIG. 1 is a block diagram of an embodiment of a music program content event recording system;

FIG. 2 conceptually illustrates a music program content stream in the received program content stream that is delivered to the media device; and

FIG. 3 is a block diagram of an exemplary embodiment of the music program content event recording system implemented in a media device corresponding to a set top box.

### DETAILED DESCRIPTION

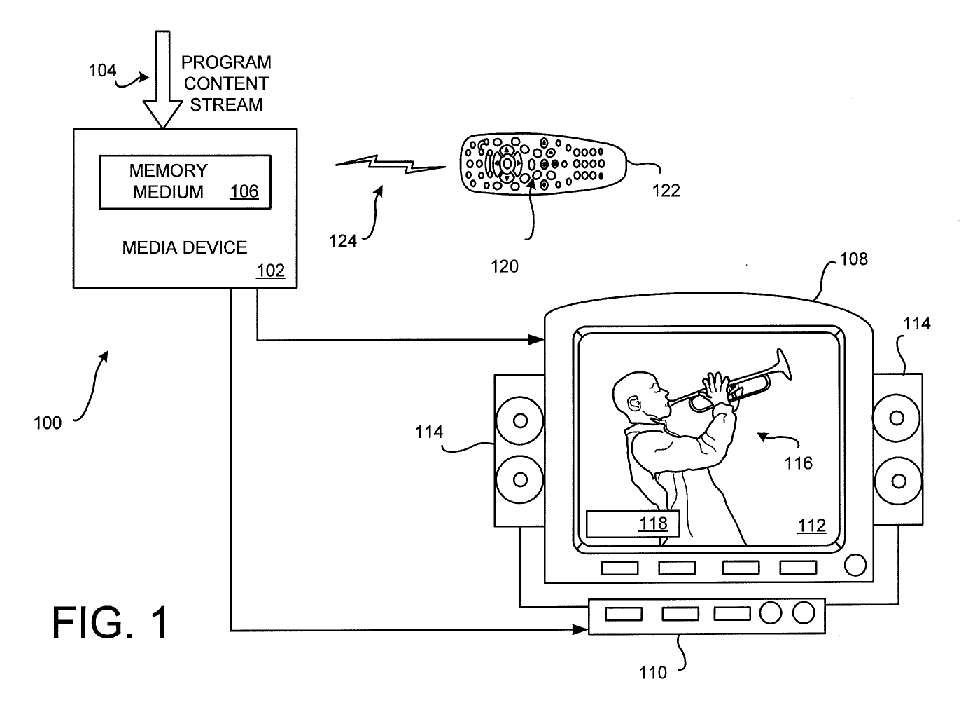

FIG. 1 is a block diagram of an embodiment of a music program content event recording system 100. Embodiments of the music program content event recording system 100 may be implemented in a media device 102 that is configured to receive a program content stream 104. The exemplary media device 102 includes, but is not limited to, a set top box (STB), a stereo, a surround-sound receiver, a radio, a television (TV), a digital video disc (DVD) player, a digital video recorder (DVR), a game playing device, or a personal computer (PC).

The program content stream 104 may comprise one or more streaming types of program content, such as a stream of music program content. Other exemplary program content streams may include movies, local programming, and/or special events. When the program content stream 104 comprises a series of music program content events, a user (not shown) is able to cause the music program content event recording system 100 to store selected music program content events of interest in a memory medium 106 residing in, or coupled to, the media device 102.

Embodiments of the music program content event recording system 100 are configured to identify and/or determine the beginning and end of a selected music program content event. Based on the determined beginning and end of the selected music program content event, the entirety of the event may be stored regardless of when the user makes the selection.

Further, information pertaining to the individual selected music program content events of interest may be optionally saved. Such information may be obtained or determined in a variety of manners. Exemplary information pertaining to individual music program content events include a song title, an album title, an artist identity, a recording label identity, a recording date, etc.

To illustrate, take for example, that the media device 102 is coupled to a television 108 and a surround sound receiver 110. Further, take for example that the program content stream 104 is, or includes, a “music channel” that is providing a series of music videos (music program content events). The user may watch the video portion of the presented music videos on the display 112 of the TV 108, and listen to the audio portion of the currently presented music program content event that is reproduced as sounds by the speakers 114 of the surround sound receiver 110.

In this example, also take for example that the currently presented music program content event presents a video clip of a trumpet player 116 on the display 112 of the TV 108. Concurrently with presentation of the video clip of the trumpet player 116, the audio portion will be a synchronized presentation of the music being played by the trumpet player 116.

During presentation of the music program content event, an identifier 118 presenting textual or graphical information pertaining to the currently presented music program content event may be presented on the display 112. For example, the identifier 118 may be a banner, popup, window or the like. The identifier 118 may be embedded into the video portion of the music program content event and/or may be provided as meta data or the like that is used to generate the information presented in the identifier 118. The identifier 118 may be presented at selected times, such as at the start and/or conclusion of the musical performance by the trumpet player 116, or may be continuously presented during the entire performance.

At some point during the current presentation of the music program content event, the user may realize that they would like to record this particular music program content event. For example, the user may like the music itself, or may be interested in the trumpet player 116 who is playing the music.

To record the music program content event of interest, the user provides a request (specification) to store the music program content event or interest, in the form of a selection command that is communicated to the media device 102. In an exemplary embodiment, the request may be initiated by actuating one or more of a plurality of controllers 120 on a remote control 122. The remote control 122 emits a wireless signal 124 that is received by the media device 102. When the media device 102 receives the selection command in the wireless signal 124, the selected music program content event is saved in its entirety into the memory medium 106 based on the determined beginning and the determined end of the selected music program content event.

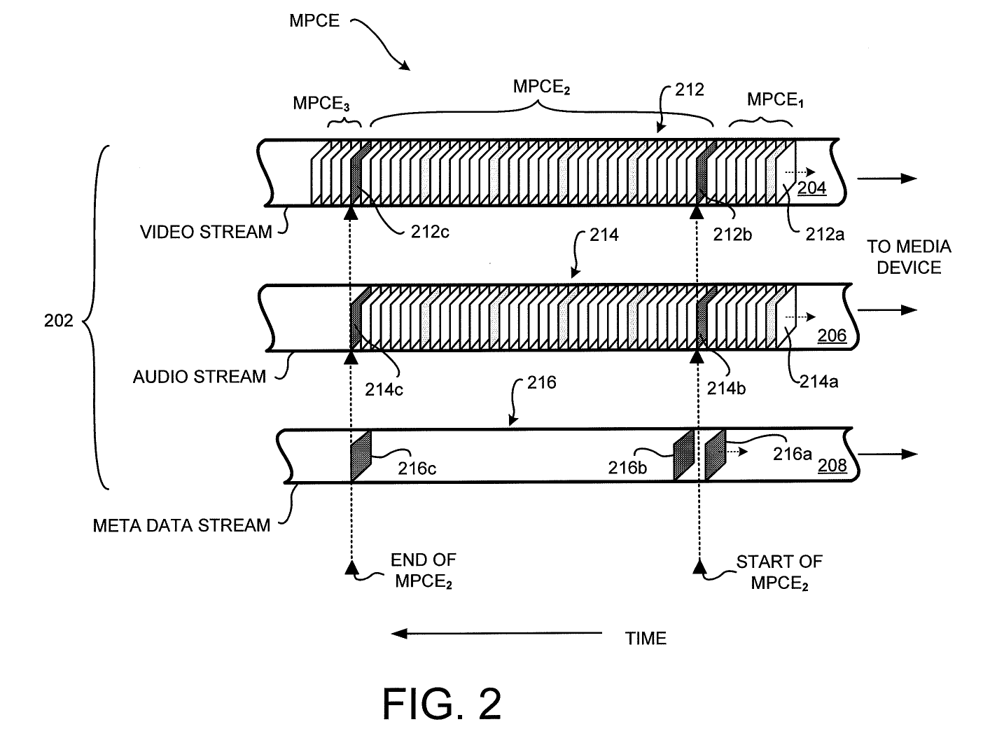

FIG. 2 conceptually illustrates a music program content stream 202 in the received program content stream 104 that is delivered to the media device 102. The music program content stream 202 comprises a series of presented music program content events (MPCEs). The music program content stream 202 is illustrated as comprising an optional video stream portion 204 (present when the music program content event is a music video, musical performance show, or the like), an audio stream portion 206, and an optional meta data stream portion 208.

The conceptualized video stream portion 204 comprises a series of communicated video frames 212. Each video frame 212 corresponds to a single video frame that is communicated to a media presentation device, such as the exemplary television 108 (FIG. 1). The video frames 212 may be received at the media device 102 in a digital data package multiplexed into the music program content stream 202. For example, if the motion pictures expert group (MPEG) format is used, the video frames 212 are configured as a series of I-frames, P-frames and/or B-frames.

The audio stream portion 206 may also be communicated as digital data, here conceptually illustrated as discrete audio packets 214, that is processed and assembled into an audio stream. Presentation of the audio portion of the currently presented music program content event is coordinated with the presentation of the associated music program content event video frames 212. Conceptually, these discrete audio packets 214 are illustrated as associated temporarily with a corresponding one of the video frames 212. Depending upon the format of the program content stream 202, one, two, five or more audio channels may be available (separately, or multiplexed into a single audio stream portion 206).

Optionally, the meta data stream portion 208 may be included. Information in the meta data stream portion 208 may identify the channel or station identifier of the music channel that is providing the music program content events. Information in the meta data stream portion 208 may also include information pertaining to each particular music program content event. The information in the meta data stream portion 208 is conceptually illustrated as a discrete meta data information packet 216.

It is appreciated that FIG. 2 conceptually illustrates the music program content stream 202 as the video stream portion 204, the audio stream portion 206, and the meta data stream portion 208. In practice, the music program content stream 202 may be provided in other formats. For example, the video stream portion 204, the audio stream portion 206, and/or the meta data stream portion 208 may be interleaved or otherwise integrated into a single data stream. Embodiments of the music program content event recording system 100 may be configured to store selected music program content events that are provided in any suitable format.

In practice, during presentation of the first illustrated music program content event (MPCE₁), at some point the video frame 212a is presented on the exemplary display 112. Concurrently, the audio data portion 214a provides the corresponding music from the speakers 114 that is synchronized with the presentation of the video frame 212a. As presentation of the video frames 212 and audio data portions 214 continue in a serial fashion, the viewer sees and hears the first music program content event (MPCE₁). A discrete meta data information packet 216a is illustrated to indicate that information pertaining to the first music program content event (MPCE₁) is available. The information in the discrete meta data information packet 216a, here conceptually illustrated near the end of the first music program content event (MPCE₁), may be presented in the identifier 118 as textual or graphical information pertaining to the ending first music program content event (MPCE₁). Such information may include the song title, album title, artist identity, recording label identity, recording date, etc., of the first music program content event (MPCE₁).

At some point, the first music program content event (MPCE₁) concludes. Then, the second music program content event (MPCE₂) begins. For illustration purposes, the beginning of the second music program content event (MPCE₂) is indicated by the video frame 212b. The start of the music for the second music program content event (MPCE₂) is illustrated as the audio data portion 214b. Further, a discrete meta data information packet 216b is illustrated to indicate that information pertaining to the second music program content event (MPCE₂) is available. The information in the discrete meta data information packet 216b, here conceptually illustrated near the start of the second music program content event (MPCE₂), may be presented in the identifier 118 as textual or graphical information pertaining to the starting of the second music program content event (MPCE₂).

In the event that the user selects the second music program content event (MPCE₂) for storage, an exemplary embodiment of the music program content event recording system 100 identifies the start of the second music program content event (MPCE₂) based on the occurrence of at least one of the video frame 212b, the audio data portion 214b, and/or the meta data information packet 216b. Embodiments may identify the start of the second music program content event (MPCE₂) based on other characteristics of the information in the music program content stream 202.

Once the start of the second music program content event (MPCE₂) has been identified, embodiments initiate storage of second music program content event (MPCE₂) based on the identified start. The initial portion of the second music program content event (MPCE₂) may be stored in any suitable memory medium by the various embodiments.

As the initial portion of second music program content event (MPCE₂) is being extracted, the remaining portion of the second music program content event (MPCE₂) may still be in the process of being received in the music program content stream 202. This portion of the second music program content event (MPCE₂) is also stored. (Alternatively, the music program content stream 202 with the remaining portion of the second music program content event (MPCE₂) may have already been received and stored.)

An exemplary embodiment of the music program content event recording system 100 then identifies the conclusion of the second music program content event (MPCE₂) based on characteristics of the information in the music program content stream 202. As the remaining portion of the second music program content event (MPCE₂) is being received and stored, embodiments monitor the music program content stream 202 to identify the conclusion. Alternatively, if the second music program content event (MPCE₂) has already been received and stored, embodiments monitor for the conclusion as the remaining portion is extracted from the memory.

An exemplary embodiment identifies the conclusion of the second music program content event (MPCE₂) based on the occurrence of at least one of the last video frame 212c, on the last audio portion 214c, and/or on an ending meta data information packet 216c. Another exemplary embodiment may identify the conclusion of the second music program content event (MPCE₂) based on the occurrence of a first video frame of the third music program content event (MPCE₃), the first audio data portion of the third music program content event (MPCE₃), and/or an starting meta data information packet of the third music program content event (MPCE₃). Some embodiments may identify the conclusion of the second music program content event (MPCE₂) based on the occurrence of other program segments, such as a commercial, commentary by a moderator, or other non-music type of segment.

Based on the identification of the start of the second music program content event (MPCE₂) and the conclusion of the second music program content event (MPCE₂), embodiments of the music program content event recording system 100 may save the selected second music program content event (MPCE₂). Further, related information may be processed as saved into a format that is compatible with information used by other applications that are used to manage a collection of saved music program content events, such as a music “jukebox” or the like.

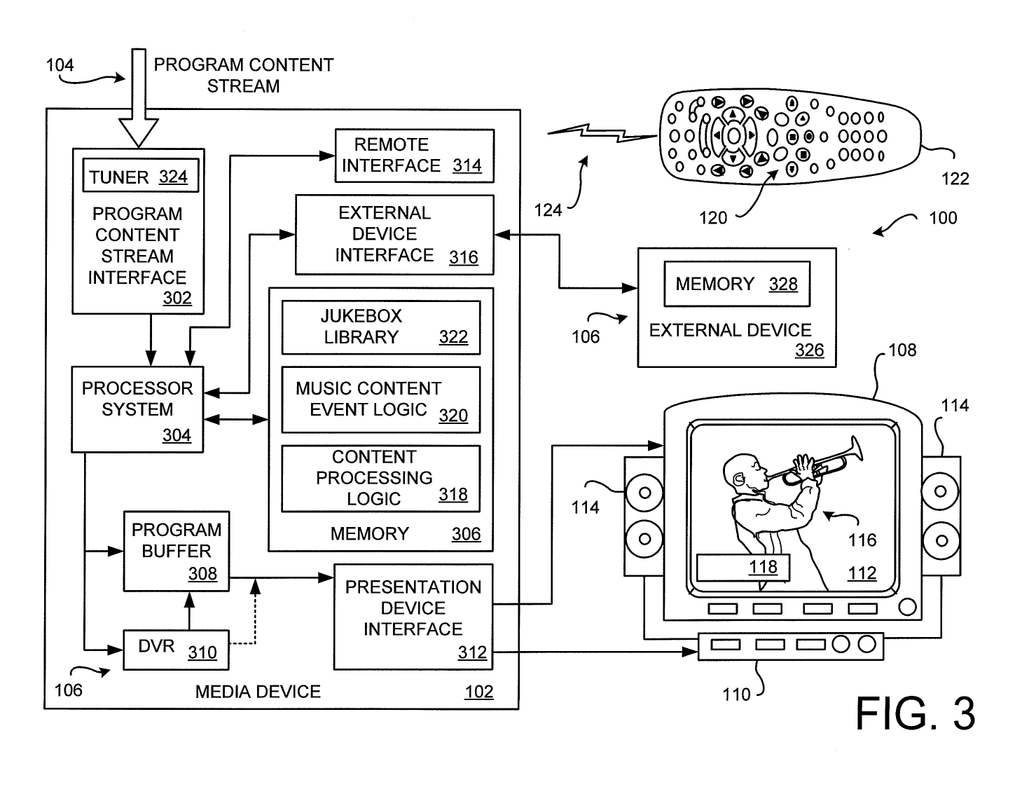

FIG. 3 is a block diagram of an exemplary embodiment of the music program content event recording system 100 implemented in a media device 102 corresponding to a set top box (STB). The non-limiting exemplary media device 102 comprises a program content stream interface 302, a processor system 304, a memory 306, a program buffer 308, an optional digital video recorder (DVR) 310, a presentation device interface 312, a remote interface 314, and an optional external device interface 316. The memory 306 comprises portions for storing the content processing logic 318, the music content event logic 320, and an optional jukebox library 322. In some embodiments, the content processing logic 318 and/or the music content event logic 320 may be integrated together, and/or may be integrated with other logic. In some embodiments, the program buffer 308 may be a portion of another persistent or non-persistent memory medium, such as the DVR 310, memory 306, or the like. Further, in various embodiments, the DVR 310 may be, or may be replaced by, another suitable persistent or non-persistent memory medium. Other media devices may include some, or may omit some, of the above-described media processing components. Further, additional components not described herein may be included in alternative embodiments

The functionality of the exemplary media device 102, here a STB, is now broadly described. A user (not shown) may view and listen to various program content when presented on the exemplary television 108 and/or the exemplary surround sound receiver 110. The media device 102, and/or other various media devices that it is communicatively coupled, is controllable based upon received user commands, typically generated at and transmitted from the remote control 122 as a wireless signal that is received by the remote interface 314. Accordingly, available program content may presented in accordance with generated user commands.

A media content provider provides program content, including the music program content events, that is received in the exemplary program content stream 104. The program content stream 104 may be communicated to the media device 102 from a media system sourced from a remote head end facility (not shown) operated by the media content provider. Non-limiting examples of such media systems include satellite systems, cable systems, and the Internet. For example, if the media content provider provides programming via a satellite-based communication system, the media device 102 is configured to receive one or more broadcasted satellite signals detected by an antenna (not shown). Alternatively, or additionally, the program content stream 104 can be received from one or more different sources, such as, but not limited to, a cable system, a radio frequency (RF) communication system, or the Internet.

The program content stream 104 is received by the program content stream interface 302. Some media devices 102 are configured to receive multiple program content streams from one or more media systems.

One or more tuners 324 in the program content stream interface 302 selectively tune to one of the program content streams 104 in accordance with instructions received from the processor system 304. The processor system 304, executing the content processing logic 318, and based upon a request for a program of interest specified by a user, parses out program content associated with a series of music program content events. The program content, and in particular the series of music program content events which the user may select to store, is then assembled into a stream of video and/or audio information. The stream of audio and video information may then be stored by the program buffer 308 such that the program content can be streamed out to the media presentation device, such as the television 108 and/or the surround sound receiver 110, via the presentation device interface 312. Alternatively, or additionally, the program content may be saved into the DVR 310 for later presentation.

The above processes performed by the media device 102 are generally implemented by the processor system 304 while executing the content device processing logic 318. Thus, the media device 102 may perform a variety of functions, such as receiving program content, processing the received program content, receiving commands for the remote control 122, and transmitting program content to one or more media presentation devices, such as the exemplary television 108 and/or the surround sound receiver 110.

When a user selects a particular one of the received specified music program content events for saving, the processor system 304, executing the music content event logic 320, determines or otherwise identifies the start of the specified music program content event. In an exemplary embodiment, since the processed music program content stream 202 is buffered into the program buffer 308 for some duration, it is highly probable that the initial portion of the specified music program content event is retrievable from the program buffer 308. Alternatively, or additionally, a music program content steam 202 may be stored on a persistent storage medium, such as a hard drive, for on-demand playback to a user. Embodiments examine the contents of the program buffer 308 to determine or otherwise identify the start of the specified music program content event. For example, if the user selects the currently presented music program content event, then the contents of the program buffer 308 may be “rewound” and examined by an exemplary embodiment to determine or otherwise identify the start of the specified music program content event. Music program content may be examined in any suitable manner to determine or otherwise identify the start of the specified music program content event.

Once the start of the specified music program content event is determined or otherwise identified, some exemplary embodiments extract and/or store the music program content event from the buffer 308 into another memory medium, such as the DVR 310, for persistent storage. Various non-volatile memory devices, such as hard drives, flash memory and the like are available for persistent storage of program content. In other embodiments, a music program content event may be extracted from a larger file containing a continuous stream of content and may be stored separately on the memory medium. Likewise, undesired portions of a continuous stream of content may be discarded from a file during an extraction process, leaving the music program content event data on the original file stored on the memory medium. Alternatively, or additionally, the music program content event may be transmitted, via the external device interface 316, to an external device 326 with a memory 328. Memory 328 may be any suitable persistent storage medium. As the remaining portions of the specified music program content event are being received in the music program content stream 202, then the remaining portion of the specified music program content event is stored as it is received. During the storing process, music program content stream 202 is monitored for the occurrence of the end of the specified music program content event.

Some embodiments may be configured to advantageously employ the program buffer 308 to facilitate retrieval and storage of the specified music program content event. For example, after the start of the music program content stream 202 has been buffered into the buffer 308, the end of the specified music program content event may be determined or otherwise identified as the music program content stream 202 is being received. Buffering of the music program content stream 202 into the buffer 308 continues. At some point, the end of the specified music program content event is determined or otherwise identified. Since the start and conclusion of the specified music program content event in the program buffer 308 is known, has been determined, or is determinable, then the entirety of the specified music program content event can be retrieved from the program buffer 308 and stored into the DVR 310 (or another suitable memory medium). Alternatively, or additionally, the music program content event may be transmitted, via the external device interface 316, to the external device 326 that comprises the memory 328.

Some embodiments may be configured to alternatively, or additionally, employ the DVR 310 to facilitate retrieval and storage of the specified music program content event. For example, all of, or a relatively large portion of, the music program content stream 202 may have been previously saved into the DVR 310. The user may be listening to and/or viewing the various saved music program content events of the saved music program content stream 202. At some point during the presentation of the stored music program content events, the user may specify one of the music program content events for saving. Embodiments of the music program content event recording system 100 determine or otherwise identify the start and conclusion of the specified music program content event based upon the music program content stream 202 that has been stored in the DVR 310. Since the start and conclusion of the specified music program content event in the program buffer 308 is known, has been determined, or is determinable, then the entirety of the specified music program content event can be retrieved from the DVR 310 and re-stored into the DVR 310 (or another suitable memory medium). Alternatively, or additionally, the music program content event may be retrieved from the DVR 310 and transmitted, via the external device interface 316, to the external device 326 that comprises the memory 328.

The start and the conclusion of a specified music program content event may be determined or otherwise identified in one or more ways. Some music program content events include markers, tags, and/or other identifiers associated with the start and/or end of each music program content event. Embodiments of the music program content event recording system 100 may be configured to monitor the occurrence of and/or detect such markers, tags, and/or other identifiers. The markers, tags, and/or other identifiers may be included in one or more of the video stream portion 204, the audio stream portion 206, and the meta data stream portion 208.

Some music program content events have a brief period of silence between music program content events. Alternatively, or additionally, there may be a blank video frame 212 or the like that demarks the start and/or conclusion of the music program content events. Embodiments of the music program content event recording system 100 may be configured to monitor the occurrence of and/or detect periods of silence and/or blank video frames 212 to identify the start and/or conclusion of the music program content events.

Some music program content events may include the identifier 118 presenting textual or graphical information pertaining to the currently presented music program content event that is presented on the display 112. Embodiments of the music program content event recording system 100 may be configured to monitor the occurrence of and/or detect the identifier 118 to identify the start and/or conclusion of the music program content events.

Some embodiments may be configured to store user input that identifies the start and/or conclusion of the music program content events. For example, but not limited to, the user may provide a user command corresponding to the start and/or the conclusion of a particular music program content event of interest as they are viewing the presentation on the television 108.

Embodiments of the music program content event recording system 100 may be configured to store information pertaining to the stored individual music program content events (e.g.; song title, album title, artist identity, recording label identity, recording date, etc.). Some embodiments may be configured to incorporate or otherwise access the information in the discrete meta data information packets 216 associated with the specified music program content event. Some embodiments may be configured to store user input. For example, the user may provide a comment or the like that is stored and/or associated with the specified music program content event. Some embodiments may be configured to recognize text that may be included in the identifier 118.

Embodiments of the music program content event recording system 100 may be configured to store the specified music program content event in a format that may be useable by other applications or music media platforms. For example, but not limited to, some media devices may include the jukebox library 322. The jukebox library 322 is an application that is configured to record, manage, present stored music media (sound tracks and/or music videos). The music media may be obtained from one or more sources, such as DVDs, CDs, web sites, and/or the exemplary music program content stream 202. The music media may be stored in one or more formats, which may be optionally specified by the user. Stored music content may be managed in any suitable manner. For example, but not limited to, music content may be managed, categorized and/or sorted by music type, artist name, etc.

Embodiments of the music program content event recording system 100 enable a user to incorporate the specified music program content events with other music content that is recorded, managed, and/or stored in the exemplary jukebox library 322 (or in similar content storage and management systems). The specified music program content events and other music content may be stored in the memory 306, in the DVR 310, in the memory of another external device 326, or in any other memory media.

Since a user may specify the start and conclusion of a music program content event, other media may now be incorporated with music content that has been recorded, managed, and/or stored in the exemplary jukebox library 322 (or in any suitable content storage and management system). For example, the user may be watching one of their favorite movies. When a particular sound track of the movie of interest is being presented, the user may specify the starting of the sound track using their remote control 122. Embodiments of the music program content event recording system 100 then store the subsequently presented sound track of the movie. Upon conclusion of the presentation of the soundtrack, the user may then generate a user command indicating the conclusion of the sound track. Accordingly, a music program content event corresponding to the sound track may be saved.

Some embodiments may be configured to allow the user to selectively store only the audio stream portion 206 (FIG. 2) of the specified music program content stream 202. For example, the user may be intending that the specified music program content event be configured to incorporating into a music jukebox platform of a MP3 player that is not configured with a display. Saving only the audio stream portion 206 would result in the generation of a stored music program content event that requires significantly less storage media capacity as compared to the same stored music program content event that includes the associated video information.

Some embodiments of the music program content event recording system 100 may be configured to monitor one or more sources of content for specified music program content events that are scheduled for future presentation. For example, the user may particularly like the music produced by a favorite artist. The user may configure the music program content event recording system 100 so that when music program content events associated with the favorite artist are available at the media device 102, those associated music program content events are stored. For example, but not limited to, an embodiment may monitor the meta data stream portion 208 for information identifying the favorite artist. As another example, embodiments may monitor an electronic program guide (EPG) for the name of the favorite artist. When the artist's name or the like appears in the EPG information, then the media device 102 may set its tuner 324 to receive the music program content stream 202 associated with the program identified in the EPG.

It should be emphasized that the above-described embodiments of the music program content event recording system 100 are merely possible examples of implementations of the invention. Many variations and modifications may be made to the above-described embodiments. All such modifications and variations are intended to be included herein within the scope of this disclosure and protected by the following claims.

1. A method for storing music program content events, the method comprising:
storing a content stream, wherein the content stream includes at least an initial portion of a music program content event;
receiving a request to store the music program content event;
accessing the stored content stream;
identifying a start of the music program content event in the accessed content stream; and
initiating storage of the initial portion of the accessed music program content event based upon the start of the music program content event.

2. The method of claim 1, wherein the request is received prior to receiving an end of the music program content event in the content stream, and further comprising:
receiving a continuing portion of the music program content event in the content stream; and
storing the continuing portion of the music program content event with the initial portion of the music program content event.

3. The method of claim 2, further comprising:
monitoring the content stream;
identifying the end of the music program content event in the monitored content stream; and
ending the storing of the continuing portion of the music program content event based upon the identified end of the music program content event.

4. The method of claim 2, wherein the content stream is stored in at least one of a program buffer and a first portion of digital video recorder (DVR) memory, and wherein the initial portion and the continuing portion of the music program content event are stored together in a second portion of the DVR memory.

5. The method of claim 2, wherein the content stream is stored in at least one of a program buffer and a digital video recorder (DVR) memory, and wherein the initial portion and the continuing portion of the music program content event are stored together in a jukebox library.

6. The method of claim 2, wherein the content stream is stored in at least one of a program buffer and a digital video recorder (DVR) memory, and wherein the initial portion and the continuing portion of the music program content event are stored together in a memory of an external device.

7. The method of claim 1, wherein the music program content event comprises an audio portion and a video portion, and wherein initiating storage of the initial portion of the accessed music program content comprises:
extracting the audio portion from the music program content event; and
storing the extracted audio portion.

8. The method of claim 1, wherein the request to store the music program content event is received after a conclusion of the music program content event in the content stream is received, and further comprising:
monitoring the content stream;
identifying the start of the music program content event in the monitored content stream;
storing the music program content event in response to identifying the start of the music program content event;
identifying an end of the music program content event in the monitored content stream; and
ending the storing of the music program content event based upon the identified end of the music program content event.

9. The method of claim 1, wherein the request to store the music program content event is received before the start of the music program content event in the content stream is received, and further comprising:
identifying a conclusion of the music program content event in the accessed stored content stream,
wherein the music program content event is re-stored based on the start and the conclusion of the music program content event.

10. The method of claim 1, further comprising:
identifying supplemental information in the content stream that is associated with the music program content event; and
storing the supplemental information.

11. The method of claim 1, wherein the request to store the music program content event is received after a conclusion of the music program content event residing in the content stream is received, and further comprising:
identifying the conclusion of the music program content event in the accessed stored content stream,
wherein the music program content event is re-stored based on the start and the conclusion of the music program content event.

12. A music program content storing system comprising:
a program content stream interface configured to receive a content stream, wherein the content stream includes a plurality of serially streaming music program content events, wherein at least one of the plurality of music program content events is a music program content event of interest;
a program buffer communicatively coupled to the program content stream interface, and configured to buffer the received plurality of music program content events;
a processor system communicatively coupled to the program buffer, and configured to access the stored content stream in the buffer to retrieve at least an initial portion of a music program content event of interest, and configured to store the retrieved initial portion of the music program content event of interest,
wherein the retrieved initial portion of the music program content event of interest is combined with a remaining portion of the music program content event of interest received by the program content stream interface.

13. The music program content system of claim 12, wherein the processor system is further configured to identify a start of the music program content event in the content stream accessed from the buffer.

14. The music program content system of claim 12, further comprising:
a persistent storage medium communicatively coupled to the buffer and the processor system,
wherein the initial portion and the remaining portion of the music program content event of interest are stored in the DVR.

15. The music program content system of claim 12, further comprising:
an external device interface communicatively coupled to the buffer, the processor system, and an external device with a memory medium,
wherein the initial portion and the remaining portion of the music program content event of interest are communicated to the external device via the external device interface, and wherein initial portion and the remaining portion of the music program content event of interest are stored in the memory medium of the external device.

16. The music program content system of claim 12, further comprising:
a memory communicatively coupled to the buffer and the processor system,
wherein the initial portion and the remaining portion of the music program content event of interest are stored in the memory.

17. The music program content system of claim 16, wherein the memory comprises a music jukebox library comprised of a plurality of music program content events of interest, and wherein the initial portion and the remaining portion of the music program content event of interest are stored in the music jukebox library.

18. The music program content system of claim 12, further comprising:
a remote interface communicatively coupled to the processor system and a remote control, wherein the remote interface is configured to receive the request to store the music program content event of interest from the remote control,
wherein the initial portion and the remaining portion of the music program content event of interest are stored in response to receiving the request.

19. A method for storing music program content events, the method comprising:
receiving a continuous stream of at least audio content, the continuous stream including at least a first music program content event followed by an initial portion of a second music program content event;
receiving a request to store the second music program content event;
identifying the start of the second music program content event in the continuous stream;
extracting the initial portion of the second music program content event from the continuous stream; and
storing the initial portion of the second music program content event separately from the continuous stream based on the identified start of the requested music program content event.

20. The method of claim 19, further comprising:
receiving a remaining portion of the second music program content event;
identifying an end of the second music program content event;
storing the remaining portion of the second music program content event with the initial portion of the second music program content event, wherein the remaining portion of the requested music program content event is defined by the identified end of the second music program content.
